(19) United States
(12) Patent Application Publication
(10) Pub. No.: US 2003/0115907 A1
(43) Pub. Date: Jun. 26, 2003

(54) Multiple lens molding system and method

(76) Inventors: Edward K. Patton, Orlando, FL (US); Layne Howell, Sanford, FL (US); Jean-Luc Nogues, Winter Springs, FL (US)

Correspondence Address: Jacqueline E. Hartt, Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/949,129

(22) Filed: Sep. 7, 2001

(51) Int. Cl. C03B 11/00; C03B 23/02

(52) U.S. Cl. 65/106; 65/286; 65/305

(57) ABSTRACT

A method for forming a plurality of optical elements simultaneously includes placing a transfer material against an inner surface of a master die, which has a shape commensurate with a desired shape of a plurality of optical elements to form a molding die, which thereby has an inner surface substantially a negative of the master die's inner surface. A moldable sheet, such as glass, is pressed against the molding die to form a unitary molded sheet, and the molded sheet is cut apart to form a plurality of optical elements, including lenses or other optical elements as desired.

### BACKGROUND OF THE INVENTION

1. Field of the Invention

The present invention relates to systems and methods for manufacturing lenses, and, more particularly, to such systems and methods for manufacturing a plurality of lenses simultaneously.

2. Description of Related Art

Glass micro-optical elements are known to be created by etching and molding. However, manufacturing such elements singly is known to be expensive and time-consuming. High-performance lenses are currently manufactured as singlets or wafers produced using costly lithographic and etching techniques. Lenses so produced are expensive and are difficult to mass produce, thereby limiting their usage in optical components and modules.

Typically to press mold glass optics, a single gob or spherical preform of glass is loaded into a mold die. The set has a top and bottom mold and in the case of diffraction-limited lenses these molds are held to submicrometer form and finish tolerances and compensated for thermal expansion during the pressing cycle. The mold is then heated above the T_{g} of the glass, typically in inert atmospheres, and pressure is applied to the mold set to form and flow the glass to conform to the profile of the mold. In pressing such arrangements care must be taken to design the preform or gob glass so that air is not trapped in the mold cavities during the press operation. After cooling the lens is removed from the mold. With the use of the molding strategy above, the surface quality of the preform or gob is of prime importance because it determines the surface quality of the final lens. During the pressing operation the surface of the preform is only moved, and a fresh surface is not generated.

Beattie (U.S. Pat. No. 3,806,079) teaches a mold assembly for plastic lenses that has at least two mold members, each having multiple, separated mold portions formed thereon. The lens array of Monji et al. (U.S. Pat. No. 5,276,538) includes a press molding device having a surface corresponding to the desired microelement array. Low-melting-point glass spheres are positioned between the formed surface and a transparent glass substrate and press molded.

The method of Kashiwagi et al. (U.S. Pat. No. 5,405,652) includes placing a glass plate between a molding die and a flat die. Umetani et al. (U.S. Pat. No. 5,436,764) disclose a method for manufacturing a micro-optical element such as a microlens array. The apparatus of Hirota (U.S. Pat. No. 5,421,849) includes a plurality of chambers accessible by rotating a table holding molds and glass materials to form molded articles by subjecting the molds and glass to successive processing steps in the chambers.

### SUMMARY OF THE INVENTION

It is therefore an object of the present invention to provide a system and method for manufacturing a plurality of micro-optical elements simultaneously.

It is also an object to provide such a system and method for economically producing high-performance lenses, lens arrays, diffractive optics, and other such optical elements.

It is an additional object to provide such a system and method for manufacturing such elements of glass.

It is a further object to provide such a system and method using press molding.

These objects and others are attained by the present invention, a system and method for creating a plurality of optical elements simultaneously. The method comprises placing a sheet of transfer material against an inner surface of a master die, which has a shape commensurate with a desired shape of a plurality of optical elements.

A molding die is formed from the transfer material that has an inner surface substantially a negative of the master die's inner surface. A moldable sheet is pressed against the molding die to form a unitary molded sheet, and the molded sheet is cut apart to form a plurality of optical elements.

This invention achieves a cost-effective manufacture of diffraction-limited, aspheric-profiled, high-NA lenses in an array or wafer format. In a preferred embodiment, lenses are pressed from a single plate of moldable glass. After molding, this plate contains many high-quality micro-optical elements. These lenses are then removed from the plate using such a technique as dicing, coring, or grinding, enabling the cost-effective mass production of diffraction-limited lenses.

Among the advantages of the present system and method, by molding many optical elements on the same plate (wafer), handling, raw material, and inspection costs are also much lower. Mold costs are reduced because many lenses are produced per press operation. Process uniformity is better than if the lenses had been produced one at a time.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a side cross-sectional view of the master die used to create molds.

FIG. 2 is a side cross-sectional view of the electroplating process, with the master die overlaid with the transfer sheet.

FIG. 3 is a side cross-sectional view of the molding die overlaid with the glass preform sheet to be molded.

FIG. 4 is a side cross-sectional view of the pressing process, with the sheet press molded upon the molding die.

FIG. 5 is a side cross-sectional view of the molded sheet of completed wafers.

FIG. 6 is a side cross-sectional view of the cut-apart wafers after dicing.

FIG. 7 is a side cross-sectional view of two-sided wafer molding.

FIG. 8 is a schematic diagram of the method steps of the present invention.

### DETAILED DESCRIPTION OF THE PREFERRED EMBODIMENTS

A description of the preferred embodiments of the present invention will now be presented with reference to FIGS. 1-8.

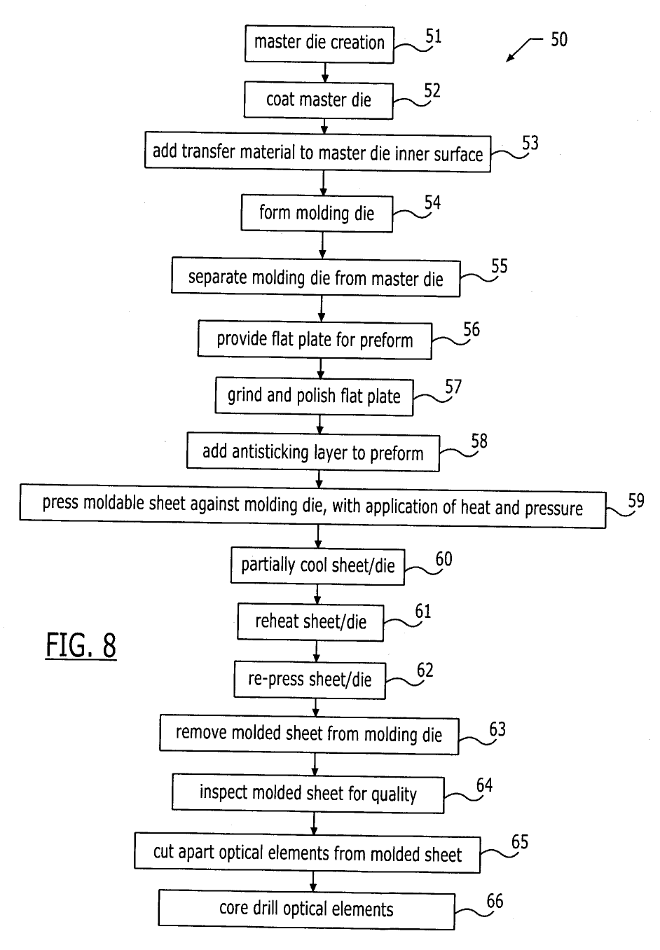

A method and system 50 for creating a plurality of optical elements simultaneously (FIG. 8) comprises the steps of providing a master die 10 that has an inner surface 11 having a shape commensurate with a desired shape of a plurality of optical elements. FIG. 1 is a sectional view of the master die 10 used to create molds. The master die 10 was created prior to the mold manufacturing process using one of the following methods 51: etching techniques, grey-scale lithography, stamping/embossing, diamond turning, polishing, or press molding, such as are known in the art, although these are not intended as limitations. Arrays of refractive or diffractive optics can be formed using etching techniques forming binary stepped elements or by using grey-scale lithographic processes, such as those disclosed in U.S. Pat. Nos. 5,218,471 and 5,161,059, to produce analog or refractive lenses. Lithography can be used to produce refractive lens arrays by building up a binary element then reflowing the photoresist (U.S. Pat. No. 4,689,291). Another method of producing lens arrays is using a stamping or embossing technique into copper or brass, or finally the master can be built up, forming individual elements by diamond turning, polishing, or press molding then building elements into a plate to form the arrays.

Using the master 10 formed as described above, a copy suitable for press molding glass can be formed using several techniques. Because electroplating is a well-known and established process, as disclosed in U.S. Pat. No. 5,783,371, and because it can copy master details with a high degree of precision and accuracy, it is an ideal process to replicate fine optical features such as lens arrays. The master stamper 10 can also be formed using a harder nickel by electroless nickel-plating techniques and noble metals. And finally the master stamper 10 can be formed in carbides using techniques detailed in, for example, U.S. Pat. No. 5,405,652.

After the master 10 is formed, it can be coated 52 with a protective coating to extend the life of the mold. For nickel masters coatings of titanium nitride and silicon carbide are used. Diamond-like coatings can be used successfully to dramatically extend the life of molds, as disclosed in U.S. Pat. Nos. 5,202,156 and 5,026,415.

The features on the inner surface 11 are shown as convex protrusions 12. The master die's inner surface 11 may also include features, such as at least one of a registration mark, a holding flange, and a ferrule for a fiber.

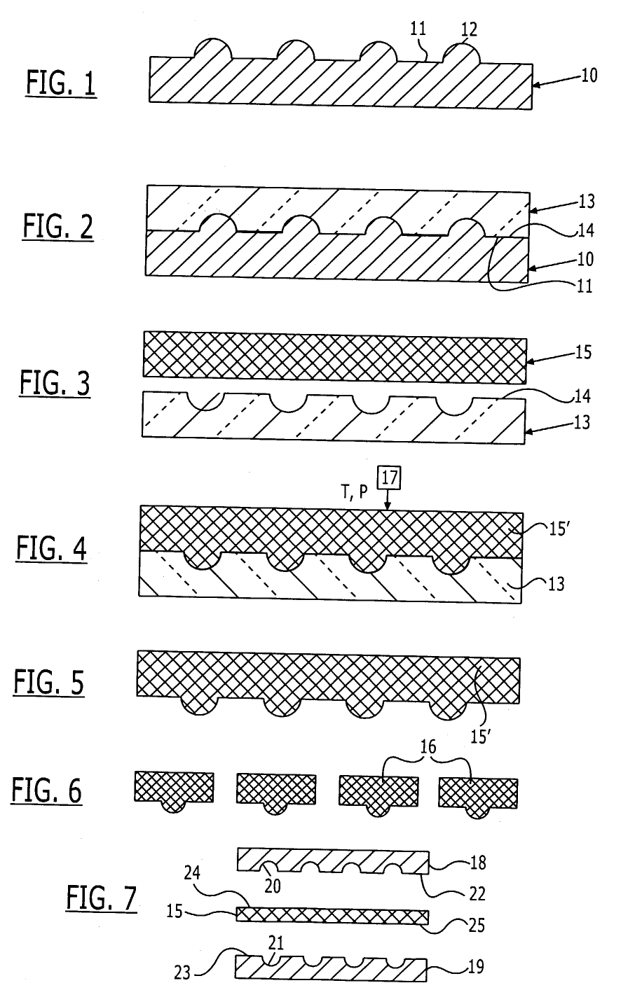

A transfer material, for example, nickel, is introduced 53 against the master die's inner surface 11, such as by electroplating, although this is not intended as a limitation, and a molding die 13 is formed 54 from the transfer material, the inner surface 14 of which is substantially a negative of the master die's inner surface 11. FIG. 2 is a sectional view of the process used to create a mold, including a method such as electroplating or electroless nickel plating.

The molding die 13 is separated 55 from the master die 10 in order to expose the molding die's inner surface 14 so that it may serve as a molding surface. A moldable sheet 15 (FIG. 3) is pressed 59 against the molding die 13 to form a unitary molded sheet 15′ (FIG. 4). The moldable sheet 15 may comprise, for example, glass. The glass sheet 15 may be placed either on the bottom or the top of the mold, without loss of generality. Tooling 17 applies both heat (T) and pressure (P) to the glass sheet 15 so that the glass is pressed into the convexities 12 of the mold 13. FIG. 5 is a sectional view of a completed wafer 15′ after pressing and prior to dicing.

To produce lens arrays a glass must be selected that is moldable at relatively low temperatures (<700° C.) and is chemically durable and can maintain surface accuracy when cooled. A variety of glasses are suitable, but an exemplary material comprises Corning CO550 glass for low-dispersion-type applications and Ohara type PBH 71 for high-refractive-index applications. Glass preforms must first be generated 56 before being used in the molding process.

To press a wafer, a flat plate of glass is ground and polished 57 to the needed thickness. The surface quality of this preform must be of moderate cosmetic quality and free of large scratches and digs. Before using the preform, it is given a light coating of carbon 58 by, for example, burning an alcohol in the presence of the preforms or by sputtering carbon on the plates, thus depositing a thin layer of carbon on the glass. This carbon layer produces an antisticking layer to reduce adhesion of the glass to the mold during the pressing operation.

Using wafer techniques, multiple mold cavities may be located within the mold die arrangement (FIG. 7). Top 18 and bottom 19 molding die surfaces 22,23 may each contain precision mold cavities 20,21, and very accurate alignment of these two surfaces 22,23 is required to produce high-quality lenses. The glass plate 15 can have a moderate cosmetic quality optical finish if both surfaces 24,25 are being pressed, because the glass plate 15 is being pressed into optical cavities 20,21 during the pressing operation, and a fresh surface is generated as it flows in the optical cavity.

To press the wafer the mold die 13 is loaded with the glass plate and heated above the T_{g} of the glass and then pressed. To overcome the problem of air entrapment, after the first press the molding die 13/glass plate 15 combination (the mold wafer arrangement) is partially cooled 60 then heated again 61 over the T_{g} and re-pressed 62. Upon cooling the wafer containing the lens array 15′ is removed 63 from the mold die 13 and the lenslets 16 in the array 15′ are inspected 64 for surface and wavefront quality.

After inspection 64 the molded sheet 15′ is cut apart 65 to form a plurality of optical elements 16, such as lenses, from the wafer. The lenses are then core drilled 66 to remove them from the molded sheet 15′, thus obtaining precision-molded individual lenses 16 (FIG. 6).

In a particular embodiment the bottom mold for the wafer comprises a 4×4 lens array on a square format. The top mold for this lens design is an optically flat, highly polished mold surface. The cavities on the bottom mold are on 3-mm center-to-center spacing. The overall size of the wafer top and bottom mold is 2.24 inches in diameter. The lenslets are collimating lenses by design and have a working distance of 0.228 mm. The effective focal length of the lens is 0.703 mm. The lens has a diameter of 900 μm, a sag of approximately 0.284 mm, and a central thickness of 0.800 mm. A preform of press-moldable glass is obtained. This glass is a phosphate-based glass and has a T_{g} less than 350° C. The design of this preform is a disk plate that has polished surfaces and is approximately 1 mm thick and 50 mm in diameter. This preform is loaded into the molding die, the temperature cycled to 385° C. and pressed at 60 psi for 4 min. After 4 min the molding arrangement is cooled to 240° C. and then recycled to 385° C. and pressed again for 4 min. The mold is then cooled to room temperature, and the molded wafer is removed from the molding die. The lenses are then inspected using beam-scan interferometry techniques.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A method for creating a plurality of optical elements simultaneously comprising the steps of:
forming a molding die from a transfer material by introducing the transfer material to a master die inner surface having a shape commensurate with a desired shape of a plurality of optical elements, the molding die thereby having an inner surface substantially a negative of the master die inner surface;
separating the master die inner surface from the molding die inner surface;
pressing a moldable sheet against the molding die inner surface to form a unitary molded sheet; and
cutting the molded sheet apart to form a plurality of optical elements.

2. The method recited in claim 1, further comprising the step, preceding the molding-die-forming step, for creating the master die by a method selected from a group consisting of etching, grey-scale lithography, stamping, embossing, diamond turning, polishing, and press molding.

3. The method recited in claim 1, wherein the moldable sheet comprises glass.

4. The method recited in claim 3, wherein the pressing step further comprises applying heat to the molding die.

5. The method recited in claim 4, wherein the glass comprises a chemically durable glass that is moldable at a temperature less than 700° C.

6. The method recited in claim 5, further comprising the step, prior to the forming step, of generating a glass preform from which to create the moldable sheet.

7. The method recited in claim 6, wherein the glass-preform-generating step comprises grinding and polishing a substantially flat plate of glass that is substantially free from surface imperfections.

8. The method recited in claim 7, further comprising the step of adding an antisticking layer to the ground and polished plate of glass.

9. The method recited in claim 8, wherein the adding step comprises coating the ground and polished plate of glass with a layer of carbon.

10. The method recited in claim 9, wherein the coating step comprises a step selected from a group consisting of burning an alcohol in the presence of the ground and polished plate of glass and sputtering carbon onto the ground and polished plate of glass.

11. The method recited in claim 1, wherein the forming step comprises a method selected from a group consisting of electroplating, electroless nickel plating, and forming the molding die from a carbide.

12. The method recited in claim 11, wherein the forming step comprises electroplating, and the sheet of transfer material comprises nickel.

13. The method recited in claim 1, wherein the forming step further comprises coating the molding die with a protective coating for facilitating the separating step.

14. The method recited in claim 13, wherein the protective coating is selected from a group consisting of titanium nitride, silicon carbide, and a diamondlike material.

15. The method recited in claim 1, wherein the master die inner surface comprises features, including at least one of a registration mark, a holding flange, and a ferrule for a fiber.

16. The method recited in claim 1, wherein the molding die comprises a plurality of mold cavities.

17. The method recited in claim 1, wherein:
the molding die comprises a first molding die and a second molding die, each having at least one mold cavity thereon; and
the pressing step comprises pressing the moldable sheet between the first and the second molding dies, thereby forming the unitary molded sheet having mold cavities located on both sides of the molded sheet.

18. The method recited in claim 1, wherein the moldable sheet comprises glass; and the pressing step comprises the steps of:
placing the glass sheet against the molding die inner surface;
heating the molding die to a temperature greater than the T_{g} of the glass;
pressing the glass sheet against the molding die inner surface;
cooling the molding die;
reheating the molding die; and
re-pressing the glass sheet against the molding die inner surface.

19. The method recited in claim 18, wherein the glass comprises a phosphate glass having T_{g} of less than 350° C., the heating step comprises heating the molding die to approximately 385° C., the pressing step comprises pressing at approximately 60 psi for 4 min, the cooling step comprises cooling the molding die to approximately 240° C., the reheating step comprises reheating the molding die to 385° C., and the re-pressing step comprises pressing the glass sheet against the molding die inner surface at approximately 60 psi for 4 mi.

20. The method recited in claim 19, further comprising the step, following the repressing step, of cooling the molding die to approximately ambient temperature prior to the cutting step.

21. The method recited in claim 1, wherein the optical elements comprise lenses, and further comprising the step, preceding the cutting step, of inspecting the lenses.

22. The method recited in claim 21, wherein the inspecting step comprises applying beam-scan interferometry to the lenses.

23. The method recited in claim 1, wherein the cutting step comprises cutting the optical elements apart and core drilling the optical elements to remove the optical elements from the moldable sheet.

24. A system for creating a plurality of optical elements simultaneously comprising:
a master die having an inner surface shaped commensurate with a desired shape of a plurality of optical elements;
a transfer material adapted for forming against the master die inner surface to form a molding die;
means for separating the molding die from the master die to expose a molding surface;
means for pressing a moldable sheet against the molding die to form a unitary molded sheet; and
means for cutting the molded sheet apart to form a plurality of optical elements.

25. The system recited in claim 24, further comprising means for creating the master die, the creating means selected from a group consisting of etching means, grey-scale lithography means, a stamper, an embosser, means for performing diamond turning, a polisher, and a press mold.

26. The system recited in claim 24, wherein the moldable sheet comprises glass.

27. The system recited in claim 26, further comprising means for applying heat to the molding die.

28. The system recited in claim 27, wherein the glass comprises a chemically durable glass that is moldable at a temperature less than 700° C.

29. The system recited in claim 5, further comprising means for generating a glass preform and means for generating the moldable sheet from the glass preform.

30. The system recited in claim 29, wherein the glass-preform-generating means comprises a grinder and a polisher for grinding and polishing a substantially flat plate of glass to be substantially free from surface imperfections.

31. The system recited in claim 30, further comprising means for adding an antisticking layer to the ground and polished plate of glass.

32. The system recited in claim 31, wherein the adding means comprises means for coating the ground and polished plate of glass with a layer of carbon.

33. The system recited in claim 32, wherein the coating means is selected from a group consisting of means for burning an alcohol in the presence of the ground and polished plate of glass and a sputtering device adapted to sputter carbon onto the ground and polished plate of glass.

34. The system recited in claim 24, wherein the forming means is selected from a group consisting of an electroplating device, an electroless nickel plating device, and means for forming the molding die from a carbide.

35. The system recited in claim 34, wherein the forming means comprises an electroplating device, and the sheet of transfer material comprises nickel.

36. The system recited in claim 24, wherein the forming means further comprises means for coating the molding die with a protective coating for facilitating the separating step.

37. The system recited in claim 36, wherein the protective coating is selected from a group consisting of titanium nitride, silicon carbide, and a diamondlike material.

38. The system recited in claim 24, wherein the master die inner surface comprises features, including at least one of a registration mark, a holding flange, and a ferrule for a fiber.

39. The system recited in claim 24, wherein the molding die comprises a plurality of mold cavities.

40. The system recited in claim 24, wherein:
the molding die comprises a first molding die and a second molding die, each having at least one mold cavity thereon; and
the pressing means comprises means for pressing the moldable sheet between the first and the second molding dies, thereby forming the unitary molded sheet having mold cavities located on both sides of the molded sheet.

41. The system recited in claim 24, wherein the moldable sheet comprises glass; and the pressing means comprises the steps of:
means for heating the molding die with the glass sheet placed thereon to a temperature greater than the T_{g} of the glass;
a press for pressing the glass sheet against the molding die inner surface;
means for cooling the molding die;
means for reheating the molding die; and
means for re-pressing the glass sheet against the molding die inner surface.

42. The system recited in claim 41, wherein the glass comprises a phosphate glass having a T_{g} of less than 350° C., the heating and the reheating means comprise means for heating the molding die to 385° C., the pressing and the re-pressing means both comprise means for pressing at approximately 60 psi for 4 min, and the cooling means comprises means for cooling the molding die to approximately 240° C.

43. The system recited in claim 42, further comprising means for cooling the molding die to approximately ambient temperature prior to the cutting step following the formation of the unitary molded sheet..

44. The system recited in claim 24, wherein the optical elements comprise lenses, and further comprising means for inspecting the lenses.

45. The system recited in claim 44, wherein the inspecting means comprises a beam-scan interferometer.

46. The system recited in claim 24, wherein the cutting means comprises means for cutting the optical elements apart and a core drill to remove the optical elements from the molded sheet.
